(19) United States
(12) Patent Application Publication
(10) Pub. No.: US 2008/0007635 A1
(43) Pub. Date: Jan. 10, 2008

(54) System and method for reducing the appearance of inherent random optical patterns in a light-diffusing screen

(75) Inventors: Ryan T. Hsu, Rochester, NY (US); James T. Stoops, Walworth, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/323,764

(22) Filed: Dec. 30, 2005

(51) Int. Cl. H04N 5/217; G03B 19/18

(52) U.S. Cl. 348/247; 348/222.1; 348/241; 348/250; 352/133; 348/E09.002

(57) ABSTRACT

The system according to the present invention includes a light-diffusing screen having a projected image that includes the intrinsic random optical patterns superimposed on a scene image. An electronic photosensor is used to capturing the scene image and an image processor employs algorithms that reduce the random optical patterns that are inherent to the light-diffusing screen.

### FIELD OF THE INVENTION

The invention relates generally to the field of digital signal processing, and in particular to artifact reduction in captured images. More specifically, the invention relates to using digital signal processing techniques to reduce the appearance of undesirable random optical patterns inherent to light-diffusing screens.

### BACKGROUND OF THE INVENTION

In a camera system, a light-diffusing screen (also referred to as focusing screen) is often used to form a temporary projected image of the scene for pre-visualization through a viewfinder before the scene is captured by film or other types of photosensors. In the motion-picture camera industry, the use of this projected scene image has expanded beyond viewfinders. For example, in U.S. Pat. No. 4,928,171, issued to Kline on May 22, 1990, the inventor describes a video assist system where a small amount of light from the temporary image projected on a light-diffusing screen is captured by an electronic photosensor and converted to a television signal for viewing on a video monitor. In another example, in WO 03/058951, issued to Weigel, et al, on Jul. 17, 2003, the inventors describe an image conversion system using the temporary image projected on a light-diffusing screen as a part of the light path to enable 35 mm camera lens usage on non-35 mm based cameras.

Common light-diffusing screens exhibit irregular structures that are the result of their construction process. For example, because matte disc-based focusing screens are constructed via a grinding process, they exhibit grain-like irregular structures. As a light-diffusing screen collects light from the desired scene, these irregular structures scatter and modulate incoming light in an undesirable manner, creating random optical patterns in the temporary image that is projected on the screen. Said in another way, the temporary image projected on the light-diffusing screen is the intended scene modulated by the random optical patterns caused by the irregular structures in the screen material.

When used in devices where suboptimal image quality is acceptable (such as viewfinders for scene framing), random optical patterns created by the light-diffusing screen are a non-issue. However, there are applications where the image quality of the observed image is very important. In such applications, it is important to be able to obtain images that are perceptually free, or nearly free, of the random optical pattern caused by the light-diffusing screen material. That is, ideally, the images obtained should be a close representative of the desired scene as possible.

One example where image quality matters is the image conversion system described in WO 03/058951. In this conversion system, which enables use of 35 mm lenses on non-35 mm-based cameras, the scene light collected by a 35 mm lens projects a temporary image on a light-diffusing screen. The camera itself, with its own non-35 mm lens, then focuses on the light-diffusing screen, effectively using the projected image as the scene. In this application, it is important to be able to observe images free of random optical patterns caused by the light-diffusing screen material.

In another example where image quality is crucial is the video assist system described in U.S. application Ser. No. 09/712,639, filed by Eastman Kodak Company by Albadawi et al on Nov. 14, 2000. This invention enables preview of post-production color management while on a movie production set. As this is based on a video assist system, the images used for previewing color management decisions are obtained through the light-diffusing screen, which, again, is characterized by the random optical pattern of the screen. Artifact-laden images are not optimal for judging and making critical decisions on the optical attributes that constitute the projected scene image.

In both of the above examples, methods for reducing or eliminating the appearance of the random optical pattern are needed to produce images more representative of the intended scene.

The direct method to reduce or eliminate the appearance of the random optical pattern is to control the irregular structures (striations) in the material used to make the light-diffusing screen. For example, by using super-fine grinding particles in the grinding process to produce matte discs, the irregular physical structure in the discs can be significantly reduced. However, use of fine grinding particles leads to light-diffusing screens that are too transparent (low light scattering) to produce a satisfactory intermediate image. Physical structures in other types of materials can be controlled as well. However, control in physical structure often translates to increase in cost and/or less of light transmission efficiency (for example, those that exhibit Lambertian diffuser properties).

Another method to reduce the perceived presence of the artifacts is to rapidly move the light-diffusing screen itself, as described in German patent number 2 016 183, issued to Firth et al on Oct. 29, 1970. In U.S. Pat. No. 6,749,304, issued to Jacumet, Jun. 15, 2004, the inventor improves on the concept by using a sandwich structure as one of the embodiments of his invention, with the light-diffusing screen as the middle section, moved by an attached motor. Some drawbacks with this type of solution are results of the fact that these solutions are largely electro-mechanical. The motor required to move the screen requires extra housing and a source of power. An electro-mechanical solution means moving parts, and additional power supply requirements, leading to increased possibility in malfunctions. In addition, the motor generates noise.

What is needed is a solution that does not increase cost, is compact, and does not use mechanical parts or significantly more power.

### SUMMARY OF THE INVENTION

The present invention is directed to overcoming one or more of the problems set forth above by employing a system for reducing random optical patterns inherent in a light-diffusing screen. The system according to the present invention includes:
a) a light-diffusing screen having a projected image that includes a scene optical image with the random optical patterns introduced by the screen;
b) an electronic photosensor for capturing an image; and
c) an image processor for reducing the random optical patterns inherent to the light-diffusing screen.
   Another embodiment of the present invention is directed to a method for reducing random optical patterns inherent in a light-diffusing screen that includes:
a) providing a light-diffusing screen having a projected image that includes a scene optical image with the random optical patterns introduced by the screen;
b) capturing an image with an electronic photosensor; and
c) applying image processing algorithms to reduce the random optical patterns that are inherent to the light-diffusing screen.

### Advantageous Effect of the Invention

The present invention has the following advantages:
a) no mechanical parts;
b) no additional mechanical noise; and
c) may be implemented as standalone electronic component or as part of existing electronic component.

These and other features and advantages of the present invention will be more clearly understood and appreciated from a review of the following detailed description of the preferred embodiments and appended claims, and by reference to the accompanying drawings. Identical reference numerals have been used, where possible, to designate elements that are common to the figures.

### BRIEF DESCRIPTION OF THE DRAWINGS

FIG. 1 depicts one version of a generic camera system with a light splitter that splits light between a viewfinder and a digital imaging system containing invention;

FIG. 2 depicts another version of a generic image conversion system;

FIG. 3 shows one embodiment of the Image Processor that performs spatial filtering on the luminance channel of the image;

FIG. 4 shows one embodiment of the Image Processor that performs spatial filtering on three color-channels of the image;

FIG. 5 shows one embodiment of the Image Processor that performs signal mapping operation on the luminance channel of the image;

FIG. 6 shows one embodiment of the Image Processor that performs signal mapping operation on three color-channels of the image;

FIG. 7 shows one embodiment of the Image Processor that performs spatial filtering directly on the photosensor data;

FIG. 8 shows one embodiment of the Image Processor that performs signal mapping operation directly on the photosensor data;

FIG. 9 is a block diagram of a common sigma-based filter;

FIG. 10 is a block diagram of common table-lookup procedure;

FIG. 11 shows a frontal view of a projected image with a random optical pattern; and

FIG. 12 shows the steps required to train, or populate, the lookup table.

### DETAILED DESCRIPTION OF THE INVENTION

In the following description, the present invention will be described in the preferred embodiment as a software program. Those skilled in the art will readily recognize that the equivalent of such software may also be constructed in hardware.

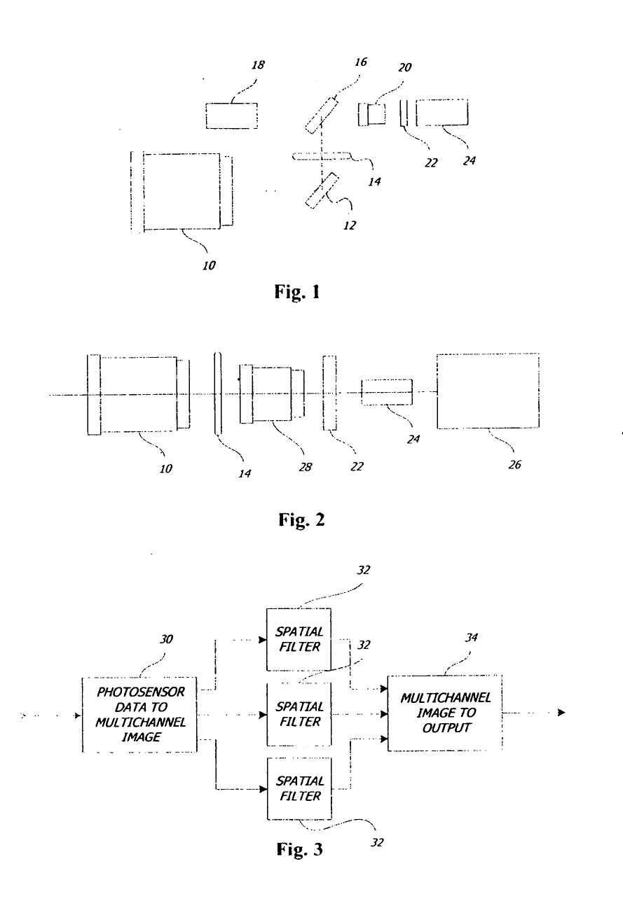

FIG. 1 and FIG. 2 show two places in a camera where a light-diffusing screen might be located. In both setups, the scene is projected onto the screen and is subsequently captured by an electronic photosensor. The Image Processor then processes the photosensor data to reduce effects of the inherent optical pattern from the light-diffusing screen.

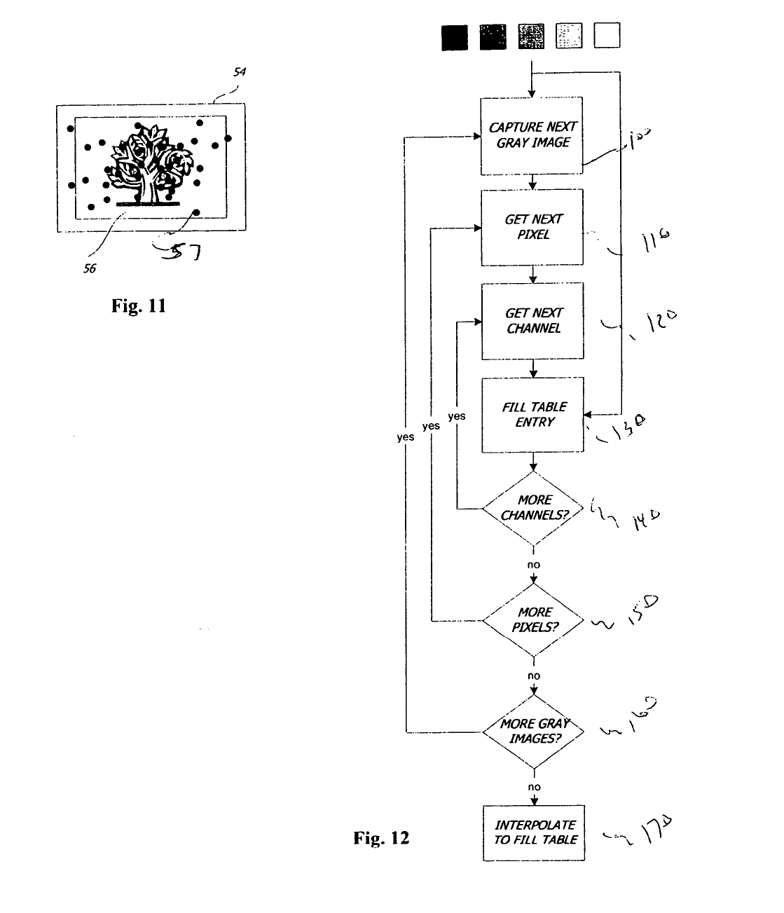

Specifically regarding FIG. 1, a camera lens 10 receives light (represented by dashed line) and directs the light onto a rotating mirror 12, whereby the rotating mirror 12 deflects the light onward towards a light-diffusing screen 14. If the rotating mirror 12 was absent, the light would pass on to a photosensing element (not shown). The light diffusing screen 14 sends the light to a light beam splitter 16, which diverts the light in at least two directions. One diversion of the light is received by a viewfinder 18. Viewfinder 18 will allow a person to view a projected image 56 (shown in FIG. 11) that will likely include random optical patterns, because of the light coming from the light diffusing screen 14, which has inherent optical patterns associated with it. The next diversion of the light is received by a relay lens 20. The relay lens 20 focuses the light onto electronic photosensor 22, whose electronic signal output will be an input for an image processor 24. The image processor 24 reduces the appearance of the inherent random optical patterns by means of digital signal processing shown in greater detail in FIGS. 3-8.

Regarding FIG. 2, a camera lens 10 receives light (represented by a solid line) and directs the light onto a light diffusing screen 14. The light diffusing screen 14 sends the light to a lens of an attached camera 28 that focuses the light onto an electronic photosensor 22, which provides an electronic signal as an input for image processor 24. Subsequent to processing the image, image processor 24 directs the light to a second attached camera 26.

FIG. 3 shows one embodiment of the Image Processor 24 shown in FIGS. 1 and 2 that uses spatial filtering to remove the random optical pattern in the light-diffusing screen 14. First, a converter 30 converts the photosensor data to a common multichannel color format, such as sRGB and YCC, in full frame, interlaced, or subsampled forms. Each color channel is then independently processed by a corresponding spatial filter 32, reducing the effects of the inherent optical pattern of the light-diffusing screen 14, which is captured as part of the projected image 56 (shown in FIG. 11). FIG. 11 shows a frontal view of a projected image 56 with a random optical pattern. Frontal view of light-diffusing screen 54 is shown with the projected image 56 having a random optical pattern 57. Spatial filters 32 are processing their corresponding red, green, or blue light in accordance with their design. Spatial filters 32 reduce the noisy signal associated with the random optical pattern 57. In one implementation, spatial filter 32 is a sigma-based filter. This sigma-based filter may be the sigma filter as described by J. Lee in his oft-quoted paper “Digital Image Smoothing and the Sigma Filter” or one that is derived from the sigma filter such as radial sigma filter described in U.S. Pat. No. 6,907,144, issued to Gindele, Jun. 14, 2005, or the more complex multiresolution method described in U.S. Pat. No. 6,937,772, issued to Gindele, Aug. 30, 2005. Lastly, a second converter 34 converts the processed color channel data into the desired output format, such as sRGB for computer monitors, YCC for NTSC video, RGB printing densities for film post-production work, or some other required image color metric or signals.

FIG. 9 shows essential parts of a sigma-based filter. The main block 46 is the sigma filter itself, which performs the calculations related to the filtering process. Sigma filter 46 gathers additional information from two attached blocks. The scaling factor expands the inclusiveness of the filter. Often, this value is based on the statistical distribution of the data, but can very well be chosen arbitrarily. Signal-dependent sigma information block 48 provides the Sigma based filter 46 with sigma values based on level of received signal. Sigma information, along with scaling factor, determines the neighboring pixels to be included in the averaging process.

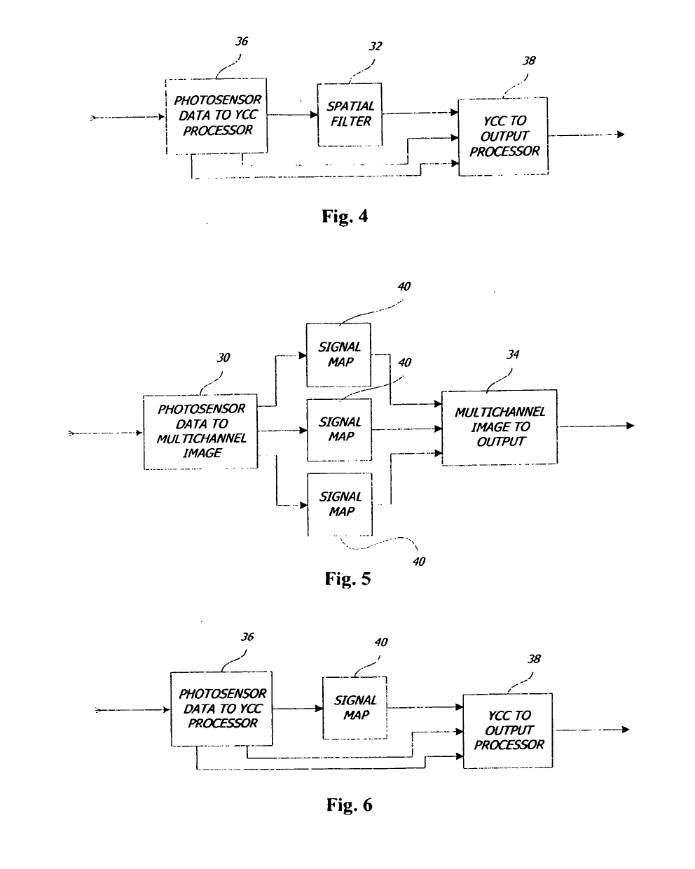

FIG. 4 shows a second embodiment of the Image Processor 24 shown in FIGS. 1 and 2. Like the embodiment shown in FIG. 3, the Image Processor 24 uses a spatial filter 32. However, this embodiment shows a special case where only one channel needs to be processed by the spatial filter 32, thereby reducing the number of calculations required for filtering. First, a converter 36 converts the photosensor data to an image comprising of one luminance data channel and two chrominance data channels. Next, only the luminance channel data is processed by a spatial filter 32. Since the random optical patterns may be characterized as changes in light intensity, processing only the luminance channel data is a valid practice. Experiments have shown that such is the case. Lastly, a second converter 38 converts the processed luminance data channel and the two unprocessed chrominance data channels to the desired output format, such as sRGB for computer monitors, YCC for NTSC video, RGB printing densities for film post-production work, or some other required image color metric or signal.

FIG. 5 shows a third embodiment of the Image Processor 24 that uses a signal mapping method to remove the random optical pattern in the light-diffusing screen. First, a converter 30 converts the photosensor data to a common multichannel color format, such as sRGB and YCC, in full frame, interlaced, or subsampled forms. Each channel is then independently processed by a signal mapping algorithm 40, thus reducing the effects of the inherent optical pattern of the light-diffusing screen, which is captured as part of the projected image 56. The signal mapping algorithm 40 reduces the appearance of random optical patterns by mapping an input signal to an expected output value. Lastly, a converter 34 transforms the processed channel data into the desired output format, such as sRGB for computer monitors, YCC for NTSC video, RGB printing densities for film post-production work, or some other required image color metric or signal.

The purpose of the signal mapping algorithm 40 is to transform the input signal value to a desired output signal value, based on prior knowledge about how one input value should be mapped to an output value. This knowledge typically comes from training the system prior to the actual start of scene capture. The signal mapping algorithm 40 itself may be one of several known techniques such as lookup-table mapping, linear interpolation, or cubic interpolation. A person with ordinary skill in the art would recognize these techniques.

In one implementation of the system, the signal mapping procedure is implemented in the form of a lookup-table mapping procedure. Lookup-table mapping has the distinct advantage in that the procedure is fast, although the technique requires a tremendous amount of hardware memory.

FIG. 10 shows essential parts of the lookup-table mapping method, as commonly practiced in the art. The lookup-table mapper 50 block uses the input signal as the index into the attached lookup table 52 and returns the signal value stored at the hardware memory location specified by the index.

FIG. 12 shows the steps required to train, or populate, lookup table 52 shown in shown in FIG. 10 and used in one implementation of the system. A series of gray patches with known signal values are used. Using a patch as the scene, operation 100 captures the projected image 56 with the electronic photosensor 22. For each pixel of the captured image operation 110 records the captured signal level and the known signal level. Likewise, for each channel of that pixel operation 120 records the captured signal level and the known signal level. These known signal levels are the output values to which this captured, input, value will be mapped when performing lookup-table signal mapping in operation 130. Operations 140, 150, and 160 repeat for all gray patches in the chosen set. Typically, a chosen set of patches may not fully populate the lookup table, that is, not all input signal values would have an output map signal value after all patches have been used. To fill in the unknown mapping values, various interpolating methods may be used in operation 170, such as linear or quadratic interpolation.

A person familiar with electronic photosensor arrays may recognize that the mapping procedure described above is similar to the common technique used to correct signal variations amongst pixels in a sensor due to differences in dark current (offset) and sensitivity (gain) of each pixel. However, the mapping procedure for the random optical patterns is unique, because the mapping procedure needs to account for the effects caused by interactions between lens light collection aperture and light-diffusing screen, which need not be accounted for in pixel-to-pixel correction.

One such effect is the non-uniformity in illumination of the light-diffusing screen, which may be a result of optical vignetting, or cosine⁴ effects (note: superscript, not a footnote), or both. Vignetting is the optical phenomenon where light intensity tends to fall off towards the edges of the formed image (in the case of this invention, at the diffusing screen) due to the size of the lens aperture. Lens aperture controls the shape of the cone of light collected by the diffusing screen, and as the lens aperture closes down (decrease in aperture size), the cone of light decreases in radius. As this cone becomes small relative to the entire area of the diffusing screen, light starts to fall off towards the edges of the projected image. Even if vignetting is not present, illumination of the light-diffusing screen may still be non-uniform due to cosine⁴ effects. Due to geometric factors described in cosine⁴ effects, points in the projected image that are off the optical-axis have lower illumination than points that are on the optical axis. An effective implementation of the lookup procedure in the present invention would also be capable of correcting these illumination falloffs due to vignetting and/or non-uniformities due to cosine⁴ effects.

The variations in the random pattern observed in the projected image as a result of changing lens apertures—that is, different lens aperture stop sizes (i.e. f/number) cause different random optical patterns in the projected image—are not inherent of electronic photosensor arrays, and therefore, the non-uniformity pattern correction that is applied in this case is limited to that resulting only from pixel gain-offset differences. An effective implementation of table lookup procedure for reducing the appearance of the random optical patterns would be capable of taking into account these variations in the patterns as lens aperture changes. Electronic photosensors do not exhibit such pattern changes in pixel-to-pixel variations, and thus need not account for such a change.

A key difference between the random optical patterns and pixel-to-pixel variations is that the light-diffusing screen affects light in a non-linear manner while the sensitivity for each pixel in an electronic sensor may be effectively modeled as linear gain. The non-linear behavior of light in the light-diffusing screen make a lookup table necessary for signal mapping, while signals captured by pixels in the electronic sensor can be modified by multiplying by a gain factor. Memory requirement for a fully (or nearly fully) populated lookup table used for random pattern correction is significantly higher than for gain-offset tables for pixel-to-pixel correction.

FIG. 6 shows a fourth embodiment of the Image Processor 24. Like the embodiment shown in FIG. 5, this one also uses signal mapping as the method to remove the random optical patterns in the light-diffusing screen. However, this embodiment shows a special case where only one single channel needs to be processed by the signal mapping procedure, thereby reducing the number of mappings required for processing. First, a converter 36 converts the photosensor data to an image comprising of one luminance data channel and two chrominance data channels. Next, signal mapper 40 processes the luminance channel data to remove the random optical pattern captured as part of the image. Lastly, a converter 38 transforms the processed luminance data channel and the two unprocessed chrominance data channels to the desired output format, such as sRGB for computer monitors, YCC for NTSC video, RGB printing densities for film post-production work, or some other required image color metric or signals.

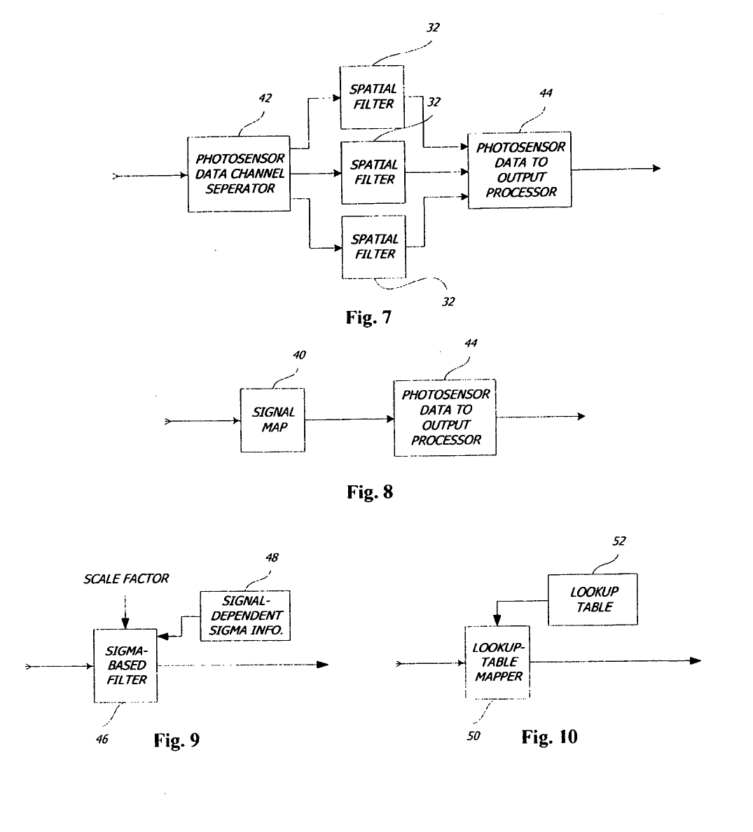

FIG. 7 shows a fifth embodiment of the Image Processor 24 that performs spatial filtering directly on the photosensor data to reduce the random pattern effects. First, a processing 42 unit separates the photosensor data into independent channels according to the number of channels incorporated into the photosensor. Common photosensors employ three color-channels, and thus is shown accordingly in the diagram. However, this need not be the case. Next, spatial filters 32 process each channel independently, reducing effects of the random optical patterns. It is appreciated that a variety of spatial filters may be used, though, as previously suggested, we favor sigma-based filters for removing random optical patterns captured as part of the projected image. Lastly, an output converter 44 converts the processed channels into the desired output format, such as sRGB for computer monitors, YCC for NTSC video, RGB printing densities for film post-production work, or some other required image color metric or signals. In a preferred implementation, the spatial filter is a sigma-based filter. Refer to FIG. 9 to see a block diagram of the sigma-based filter.

FIG. 8 shows a sixth embodiment of the Image Processor that performs signal mapping directly on the photosensor data to reduce the random pattern effects. For each pixel of the photosensor, the signal mapping block 40 maps the input signal to a desired output signal, then a converter 44 converts the processed data to the desired output format, such as sRGB for computer monitors, YCC for NTSC video, RGB printing densities for film post-production work, or some other required image color metric or signals. The signal mapping procedure itself may be one of various known techniques such as lookup-table mapping, linear interpolation, or cubic interpolation. In one implementation, lookup-table mapping is used as the mapping procedure. FIG. 10 shows a block diagram of the lookup-table mapping procedure.

The invention has been described with reference to preferred embodiments. However, it will be appreciated that a person of ordinary skill in the art can effect variations and modifications without departing from the scope of the invention.

### PARTS LIST

10 Camera lens
12 Rotating mirror
14 Light-diffusing screen
16 Light beam splitter
18 Viewfinder
20 Relay lens
22 Electronic photosensor
24 Image Processor
26 Light and processing path of attached camera
28 Lens of attached camera
30 Photosensor data to multichannel image converter
32 Spatial filter
34 Multichannel image to output format processor
36 Photosensor data to YCC image converter
38 YCC image to output format processor
40 Signal mapper
42 Photosensor data separator
44 Photosensor data to output format processor
46 Sigma-based filter
48 Signal-dependent sigma information
50 Table lookup processor
52 Lookup table
54 Light-diffusing screen
56 Projected image including random optical patterns
57 Random optical pattern
100 operation
110 operation
120 operation
130 operation
140 operation
150 operation
160 operation
170 operation

1. A system for reducing random optical patterns inherent in an light-diffusing screen, comprising:
a) a light-diffusing screen having a projected image that includes a scene optical image with the random optical patterns superimposed by the screen
b) an electronic photosensor for capturing the projected image; and
c) an image processor for reducing the random optical patterns that are inherent to the light-diffusing screen.

2. The system claimed in claim 1, wherein the light-diffusing screen is selected from the group consisting of ground glass, pot opal glass, flashed opal, quartz, translucent polymeric and reflective diffusing materials.

3. The system claimed in claim 1, wherein the electronic photosensor is selected from the group consisting of CMOS, CCDs, photomultipliers, photodiodes.

4. The system claimed in claim 1, wherein the image processor uses spatial filtering.

5. The system claimed in claim 4, wherein the spatial filtering comprises either sigma filtering or sigma-derived filtering

6. The system claimed in claim 1, wherein the image processor employs lookup tables to map random spatial signal differences inherent in the light-diffusing screen minus the scene optical image.

7. The system claimed in claim 4, wherein the spatial filtering occurs at any image processing stage.

8. The system claimed in claim 6, wherein lookup tables are employed at any image processing stage.

9. The system claimed in claim 1, where an optical lens system forms an intermediate image on the light-diffusing screen, and where the image produced is then relayed to the photosensor by additional optical element(s).

10. A system for reducing random optical patterns inherent in an light-diffusing screen, comprising:
a) a light-diffusing screen employed in a motion picture camera having a viewfinder with a video assist, wherein the viewfinder produces a projected image that includes a scene optical image superimposed by the random optical patterns of the screen;
b) an electronic photosensor for capturing the projected image; and
c) an image processor for reducing the random optical patterns inherent to the light-diffusing screen, while minimizing degradation in the scene optical image.

11. The system claimed in claim 10, wherein the motion picture camera is a film camera or an electronic camera.

12. The system claimed in claim 10, wherein the light-diffusing screen is selected from the group consisting of ground glass, pot opal glass, flashed opal, quartz, translucent polymeric and reflective diffusing materials.

13. The system claimed in claim 10, wherein the electronic photosensor is selected from the group consisting of CMOS, CCDs, photomultipliers, photodiodes.

14. The system claimed in claim 10, wherein the image processor uses spatial filtering.

15. The system claimed in claim 14, wherein the spatial filtering comprises either sigma filtering or sigma-derived filtering.

16. The system claimed in claim 10, wherein the image processor employs lookup tables to map random spatial signal differences inherent in the light-diffusing screen minus the scene optical image.

17. The system claimed in claim 14, wherein the spatial filtering occurs at any image processing stage.

18. The system claimed in claim 16, wherein the lookup tables are employed at any image processing stage.

19. A method for reducing random optical patterns inherent in a light-diffusing screen, comprising the steps of:
a) providing a light-diffusing screen having a projected image that includes a scene optical image with the random optical patterns superimposed by the screen;
b) capturing the scene image with an electronic photosensor; and
c) applying image processing algorithms to reduce the random optical patterns that are inherent to the light-diffusing screen.

20. The method claimed in claim 19, wherein the light-diffusing screen is selected from the group consisting of ground glass, pot opal glass, flashed opal, quartz, translucent polymeric and reflective diffusing materials.

21. The method claimed in claim 19, wherein the electronic photosensor is selected from the group consisting of CMOS, CCDs, photomultipliers, photodiodes.

22. The method claimed in claim 19, wherein the image processor uses spatial filtering.

23. The method claimed in claim 22, wherein the spatial filtering comprises either sigma filtering or sigma-derived filtering.

24. A method for populating a lookup table from a series of gray patches with known signal values, comprising the steps of:
a) providing the series of gray patches with known signal values;
b) capturing a projected image of the series of gray patches with an electronic photosensor;
c) recording a captured signal level for each pixel of the captured image and a predetermined signal level for each pixel of the captured image;
d) recording a captured signal level for each channel of a pixel of the captured image and a predetermined signal level for each channel of a pixel of the captured image;
e) populating the lookup table with the predetermined signal level for each pixel of the captured image;
f) repeating steps (b-e) for all gray patches provided in step a; and
g) interpolating to populate unknown mapping values.

25. A method for reducing random optical patterns inherent in a light-diffusing screen, comprising the steps of:
a) converting an image signal into separate color data signal;
b) filtering the color data signal to remove inherent random optical patterns associated with the light diffusing screen; and
c) converting the filtered color data to a predetermined color output format.

26. The method claimed in claim 25, wherein the predetermined color output format is selected from the group consisting of sRGB, YCC, RGB, and RGB printing densities.

27. The method claimed in claim 25, wherein the step of converting an image signal into separate color data signal includes converting photosensor data to YCC processor or converting color data to a multichannel image.

28. A method for reducing random optical patterns inherent in a light-diffusing screen, comprising the steps of:
a) separating color channels received from a photosensor;
b) filtering the color data signal to remove inherent random optical patterns associated with the light diffusing screen; and
c) converting the filtered color data to a predetermined color output format.

29. A method for reducing random optical patterns inherent in a light-diffusing screen, comprising the steps of:
a) passing an electronic color signal directly into a signal mapping processor;
b) converting mapped color data from the signal mapping processor to a predetermined color output format.
